(19) United States
(12) Patent Application Publication
(10) Pub. No.: US 2024/0240283 A1
(43) Pub. Date: Jul. 18, 2024

(54) PROCESS AND PLANT FOR RECYCLING ZINC OXIDE RESIDUES

(71) Applicant: Metso Metals Oy, Espoo (FI)

(72) Inventors: Jochen GÜNTNER, Kahl (DE); Maciej WROBEL, Florstadt (DE); Dr.-Ing. Jörg HAMMERSCHMIDT, Erlensee (DE); Eberhard SCHMIDT, Reichelsheim (DE); Sebastian HIRSCH, Heidelberg (DE)

(21) Appl. No.: 18/571,022

(22) PCT Filed: Jun. 16, 2021
(86) PCT No.: PCT/EP2021/066260

§ 371 Date: Dec. 15, 2023

(51) Int. Cl. C22B 19/34; C22B 1/10; C22B 1/24; C22B 3/00; C22B 7/00; C22B 7/02; C22B 19/02; C22B 19/30; F27B 15/00

(52) U.S. Cl. CPC C22B 19/34; C22B 1/10; C22B 1/24; C22B 7/001; C22B 7/007; C22B 7/02; C22B 19/02; C22B 19/22; C22B 19/30; F27B 15/00

(57) ABSTRACT

A process and its relating plant for recycling zinc oxide residues. Thereby, zinc oxide residues are granulated to particles with a size of d₈₀ between 0.3 and 5 mm, preferably between 0.5 and 2 mm. These particles are fed into a roaster where they are thermally treated at a temperature in the range of 500 and 1.200° C., preferably 800 to 1.100° C. in a fluidized bed to form a calcine. The zinc oxide residues are zinc oxide dusts with a particle size below d₈₀ 100 μm, preferably below d₈₀ 75 μm coming from kiln, submerges lances furnaces, ferric reduction furnaces, galvanizing and/or recycling processes, particularly recycling of steel, copper, lead, nickel and/or electronic scrap, and/or that the zinc oxide residues comes from foundry for lead and zinc, ashes and/or dross from a Zamac process, oxide zinc ash, catalysts, melting and casting of Zn and/or zinc slag.

The invention is directed to a process and its relating plant for recycling zinc oxide residues, wherein the zinc oxide residues are granulated to particles with a size of d₈₀ between 0.3 and 5 mm, preferably between 0.5 and 2 mm and wherein these particles are fed into a roaster where they are thermally treated at a temperature in the range of 500 and 1.200° C., preferably 800 to 1.100° C. in a fluidized bed to form a calcine.

The recycling of waste materials is being expanded increasingly since wastes have become recognized as a resource which has the potential to be exploited more extensively. This holds particularly true for zinc. While in recent years there has been a decrease in the total production zinc, the proportion of this metal derived from secondary sources is significant. At the present time it is estimated that of the total world production 25 wt.-% Zinc production is derived from secondary sources. Apart from financial considerations, the principal ecological benefits to be derived include (i) the conservation of raw materials, thus decreasing the need to further exploit and deplete reserves of natural resources, (ii) the avoidance of wastes for ultimate disposal, thus decreasing the potential environmental pollution load and (iii) conservation of energy, in many instances variously estimated to be a saving between 40% and 85% in energy usage and reduced carbon dioxide emissions to the environment.

Also, it is important to understand that nowadays it is possible to produce metals which meet specifications and are indistinguishable from the same metals produced by their extraction from ores.

Consequently, for a variety of reasons there are strong supportable arguments why recycling of zinc becomes more and more important due to economic and ecological reason.

On the one hand, typical residues for zinc containing residues are flue dusts e.g. coming out from steel recycling producing electric arc furnace Dust, Waelz oxide, and/or their cleaned final products after halogen removal, coming from top submerged lances-processes, e.g. Ausmelt, or Isasmelt, coming from ferric reduction residues, coming from galvanizing, coming from copper or electronic scrap recycling processes, coming out of lead recycling processes or coming out of nickel recycling processes. The zinc content in dust is in the range of 40-80 wt.-%, typical wt. —60-70%. Zinc

On the other hand, zinc dross and residues containing zinc oxide coming out of foundry for lead and zinc, ash and dross coming from a Zamac process, ashes containing zinc oxides, catalysts and zinc slag could a source for zinc containing residues which have to be recycled. Zinc content in dross/sludge material is in the range 80-99%.

Typical reactor types for a roasting process are fluidized bed reactor, rotary kiln or multiple hearth furnace. In case of a fluidized bed reactor, gases and at least small particles of the roasted concentrate (calcine) are withdrawn over the top of the roaster and fed into at least one separating device for separating solid particles. The at least one gas-solid separating device can be designed as cyclone(s) connected in parallel or in series, evaporative cooler and/or waste heat boiler (combined called cooler). Further, an electrostatic precipitator (ESP) is foreseen downwards of the separating device, which is why a cooling of the gas-solid-mixture is particularly important. Using a waste heat boiler has the additional advantage of producing saturated/superheated steam for internal use or for electricity production. Even though a fluidized bed reactor has the big advantages of very good heat and mass transfer rates, this after-treatment of the withdrawn fluidized gas and contained particles lowers the overall rentability.

It is state of the art to recycle particles from the gas-solid separation device to enhance the residence time, and, therefore, ensure a higher rate of calcination as well as a lower carbon and/or sulfur content. However, a fraction of particles with very low diameters, especially below 10 μm, are so small that they are not separated selectively in the separation device and passed back into the reactor, but are withdrawn together with a gas stream into the latter process steps.

The high amount of dust is also the reason for formation of built-ups in the waste heat boiler, which is one of reasons for frequent shutdowns. Moreover, the extensive cleaning leads also to damage of the steam bundles in the boiler.

While in current processes using concentrates, the amount of very small particles, especially with a diameter below 10 μm, is low, which means mostly below 10 wt.-%, zinc from recycling processes has much lower average diameters. Therefore, the use of a fluidized bed reactor has hardly been possible in practice up to now for the reasons described above.

Therefore, the underlying reasoning behind the current invention is to use a fluidized bed reactor for roasting of recycled material.

This object is solved by a process with the features of claim 1.

Such a process is directed to the recycling of zinc oxide residues. that the zinc oxide residues. These zinc oxide restudies are dusts with a particle size d₈₀<100 μm, preferably d₈₀<75 μm coming from kiln, submerges lances furnaces, ferric reduction furnaces, galvanizing and/or recycling processes, particularly recycling of steel, copper, lead, nickel and/or electronic scrap, and/or that the zinc oxide residues comes from foundry for lead and zinc, ashes and/or dross from a Zamac process, oxide zinc ash, catalysts, melting and casting of Zn and/or zinc slag. For the roasting in the fluidized bed, these zinc oxide residues are granulated to particles with a size of d₈₀ between 0.3 and 5 mm, preferably between 0.5 and 2 mm. Afterwards, these particles are fed into a roaster where they are thermally treated at a temperature in the range of 500 and 1.200° C.

In this context the particle-size distribution d₈₀ means that at least 80% of the contained particles features a diameter less than the given value. This holds particularly true for measurements done with a sieve analysis, photo analysis or optical counting methods

The roasting and the after-treatment is well-known and e.g. explained in detail in WO 2018/162089. However, the complete granulating of the residues makes it possible to use a fluidized bed reactor for the roasting, which allows to benefit from the advantages of very good material and heat transport.

This process according to the invention is of particularly importance for residues coming from a Waelz process. The so-called Waelz Process is a pyrometallurgical process volatilizing zinc, cadmium and lead under reducing condition. It is performed in a long, slightly inclined and refractory-lined rotary kiln (Waelz kiln). Its name Waelz derived from the German verb “Waelzen”, which describes the trundling motion of the kiln charge. In the 21st century, the Waelz process is used more widely than ever before.

Typical feed materials of a Waelz process are e.g. Zn/Pb bearing electric arc furnace steelmaking dusts, neutral leach residues of zinc smelter or other Zn bearing materials. That feed material is agglomerated prior to the feeding into the Waelz kiln in order to minimize the amount of the so-called carry over which affect the quality of the Waelz oxide.

Depending on the feed basicity the addition of a conditioner e.g. sand or limestone in needed to maintain an optimum Waelz motion of the charge. Moreover, coke breeze is added in granulation <10 mm as reductant

The feed mixture is slowly moved down by the kiln rotation and heated up by the off-gas stream leaving the kiln counter-current to the material flow. After drying and preheating the charge enters the reduction zone in which the iron and zinc oxides are reduced to the metals. At the bed temperatures of up to 1.200° C., zinc is vapourized. The material residence time is 5 to 10 hours depending on the kiln size and the degree of filling (typical: 20% vol.) zinc fumes and carbon monoxide emerging from the charge, are burnt in the freeboard with air entering the kiln at the discharge end.

As the zinc oxide originates in the gas phase, it is swept out of the kiln by the hot off-gases in a very finely divided form, which is what the difficulties causes in a latter roasting fluidized bed reactor. Other volatilized metals like lead and cadmium and some kiln feed material (carry over) are also carried over by the off-gases. The dust laden gases pass through a large dust settling chamber, where coarse particles are settled out, then to a surface or water evaporation cooler and finally to a baghouse or electrostatic precipitator in which the Waelz oxide is collected. The so-called pre-oxide consisting of kiln back-flow material and dust from the settling chamber, is recycled to the kiln inlet.

Waelz slag discharges by gravity from the lower end of the kiln at about 1.100° C. and falls through a chute into the wet slag extractor. After cooling the slag is classified and separated on a magnetic separator for recovery of unburned coke.

Typical composition of products from the Waelz process resulting from the Walez kiln are shown in table 1.

TABLE 1
Chemical analysis of typical crude
Waelz oxide European Waelz plants.

| | Crude Waelz Oxide |
|---|---|
| Zn [wt.-%] | 58-80 |
| Pb [wt.-%] | 1-8 |
| Fe [wt.-%] | 0.5-3 |
| SiO₂ [wt.-%] | 0.1-2.5 |
| CaO [wt.-%] | 0.1-2.5 |
| MgO [wt.-%] | 0.1-2.5 |
| Cd [wt.-%] | <1.0 |
| Al₂O₃ [wt.-%] | 0.1-1.0 |
| Cₜₒₜ [wt.-%] | 0.1-1.5 |
| Sₜₒₜ [wt.-%] | <1 |
| Cl [wt.-%] | <0.1-6 |
| F [wt.-%] | <0.1-0.5 |

Due to its high capacities, an improves process for the further treatment of zinc residues from a Waelz process is of particular importance

For other sources, particularly for the zinc oxide residues coming from melting and casting of zinc and/or zinc oxide, the zinc oxide residues have to be crushed to a particle size below d₈₀ 100 μm, preferably below d₈₀ 75 μm before being granulated to particles with a size of d₈₀ between 0.3 and 5 mm, preferably between 0.5 and 2 mm. The crushing and -re-granulation are necessary for a more homogeneous composition and density which is required for fluidized bed technology.

The recycling process makes particular sense from an ecological and economic point of view for all residues with relatively high zinc content. Above all, this incluedes dust with a zinc content of 40 to 80 wt.-%, preferably 60 to 70 wt.-% or dross or sludge material with a zinc content between 80 and 99 wt-%, Naturally, it is also possible to operate the process according to the invention with a mixture of dust and dross and/or sludge or the zinc oxide residues are a mixture of zinc dust and dross or sludge.

Typically, the zinc oxide residues contain halogens, carbonates, sulfides and/or sulfates which have to be removed. Especially the halogens Cl and F have to be removed together with the off-gases of the roaster to avoid high concentrations on a downward hydroplant. Preferably, washing and filtration of the dust before entering the roaster can, therefore, be simplified or even omitted in case of a fluidized bed roaster.

In addition or alternatively, in a number of embodiments the residues contain lead, which can be recycled.

Further, the zinc oxide residues can contain at least one element from a list comprising cadmium copper, arsenic, silver, PGMs, and silica, which can also be recycled from the roaster.

Moreover, it is possible to admix additional material containing zinc and/or sulfur previous and/or during and/or after granulating. The admixing of zinc enables a diluting of impurities, whereby it is particularly preferred that the overall sum of metals others than zinc is below 15 wt.-%. Using this form of dilution, also residues with a very high amount of impurities can be recycled easily. Typical sources for the admixed material is/are zinc concentrate, zinc dust (particles with size d80<60 μm), zinc oxide, sulfur containing residues dust from an electrostatic precipitator and/or dust from cyclone

An adding of sulfur containing material is an increasing of combustible material and, therefore, works as additional energy supply.

For each position of the admixing, particularly advantages can be achieved: A previous admixing leads to a very homogenous composition of the particles resulting from granulation while an admixing directly to granulation reduces CAPEX and OPEX since to additional previous blending step is required. However, in both cases a crushing of the concentrate before admixing previous to granulation or into the granulation directly to an average particle diameter of d₈₀<2 mm is preferred for improved granulation

On the other hand, an adding into the feed of the roaster or into the roaster directly leads to a lower through-put of the granulation, which can, therefore, be designed smaller.

Having a closer look to the granulation, it is also preferred to admixed water to the zinc oxide residues previous and/or during granulating, which leads to a better binding of the resulting particles.

In addition or alternatively, sulfuric acid can be admixed to the zinc oxide residues previous and/or during granulating, which also increases binding during granulation.

In this context, it is particularly preferred that the added sulfuric acid come from a zinc treatment step downward in the process, namely in a hydrometallurgical process. Said hydrometallurgical process typically contains the steps of neutral leaching, hot acid leaching, purification and electrowinning. Mostly, the acid is withdrawn from the electrowinning (spent acid). The added sulfuric acid has often a concentration of <35 wt.-%, preferably less than 30 wt.-% and even more preferably between 2 and 30 wt.-%. Most preferred, acid recycled from the electrowinning has a concentration between 12 to 18 wt.-%, preferably 14 to 16.5 wt-%, while acid coming from a wet gas cleaning has a concentration between 5 to 35 wt.-%.

This has the advantage that valuable metals as well as contained sulfur can be recovered. Moreover, sulfuric acid can be removed from the process independent from the acid's contamination or its concentration. This relieves the wastewater treatment or reduces the total flow of effluent treatment

As previously mention, it also preferred to increase the sulfur content of the particles resulting from granulation. In this context, a sulfur content of the particles is between 6 and 35 wt.-%, more preferred 8 to 30 wt.-% even more preferred 9 to 20 wt.-% (dry basis) of sulfide sulfur. The most preferred sulfur content is >10+/−0.5 wt-% (dry basis) of sulfide sulfur to achieve an autothermal process in the roasting step or at least reduced energy requirement.

Another preferred aspect of the current invention is a batch-wise operation of the granulation while the roasting is a continuous process. A batch-wise granulation has the benefit that quality of the pellets in terms of particle size, especially a smaller range of the particle size and particle stabilization, is much better since all pellets have the same residence time instead of the same average residence time

On the other hand, it is a valuable alternative that the whole process is a continuous process which enables an easier controlling.

The invention is also directed to a plant according to claim 14 enabling an operation according to any of claims 1 to 13. This particularly contains an apparatus design of the described process options.

Such a plant for recycling zinc oxide residues features at least one granulator, wherein the zinc oxide residues are pelletized to particles with a particle size of d₈₀<100 μm, preferably d₈₀<75 μm and a roaster being designed as a fluidized bed reactor, wherein the particles are thermally treated at a temperature in the range of 500 and 1.200° C. in a fluidized bed to form a calcine. This plant features further at least one apparatus for submerged lances, ferric reduction, galvanizing, recycling processes, particularly recycling of steel, copper, lead, nickel and/or electronic scrap, foundry for lead and zinc and/or a Zamac process, oxide zinc ash, catalysts and/or zinc slag.

In a preferred embodiment, a high intensive mixer is foreseen upwards of the granulator to admix water, sulfuric acid, zinc containing material and/or sulfur containing material. Thereby, a homogenous composition of the particles with very good particle stability is achieved.

In another preferred embodiment, bins for particles from the granulation are foreseen. Thereby granulation can be operated batch-wise due to the reasons explained above while a continues feed into the fluidized bed for a continuously operated roaster is possible.

Further objectives, features, advantages and possible applications of the invention can also be taken from the following description of the attached FIGURE and the example. All features described and/or illustrated form the subject matter of the invention per se or in any combination, independent of their inclusion in the individual claims or their back-references.

In the drawing:

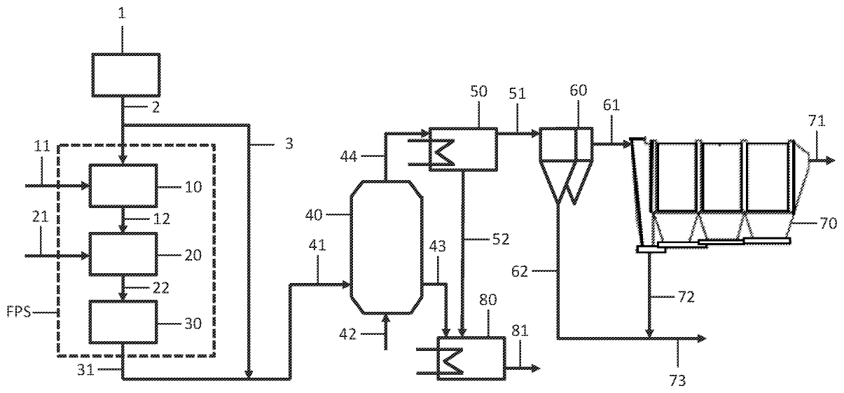

FIG. 1 shows a schematic view of the inventive reactor system

In FIG. 1 at least one apparatus for generating zinc oxide residues 1. Such an apparatus 1 is designed as at least one apparatus for submerges lances, ferric reduction, galvanizing, recycling processes, particularly recycling of steel, copper, lead, nickel and/or electronic scrap, foundry for lead and zinc and/or a Zamac process, oxide zinc ash, catalysts and/or zinc slag with or without their after-treatment device(s). Preferably, apparatus 1 symbolizes a Waelz kiln together with its after downward coiling and separation devices explained above. However, it is not necessary that the generation of the zinc oxide residues is directly connected to the recovery of the same. Often the residues are transporter to the roasting.

According to the invention, the gained zinc oxide residues are passed via conduit 2 at least partly into a Feed Preparation System FPS. Such an FPS features optionally at least one blending supply, 10, wherein the zinc oxide residues can be admixed with other solid materials, like e.g. zinc concentrate and/or sulfur containing material which would be added via conduit 11.

From there it is either passed into granulation device 20 via conduit 12 or the zinc oxide residues are passed therein directly without any blending (not shown). The granulation device 20 is preferably designed as an intensive mixer. It is used to increase the particle size of the feed material. The granulation distributes the impurities homogenous, reducing the risk of stickiness/sintering. It is preferred to add water and/or sulfuric acid via conduit 21 to increase the particles quality, particularly its stability. Source for the sulfuric acid is preferably a not-shown process step in the downward zinc preparation. Most preferred is the use of spent acid (preferably H₂SO₄ content between 14 and 18 wt.-%) from an electrowinning or a wet gas cleaning.

Optionally, the granulation device 20 is operated batch-wise. In this case, at least one bin 30 is foreseen to store the resulting particle fed in via conduit 22. this enable a continuous operation of the downward fluidized bed reactor 40, wherein roasting of the particles takes place. The particles are fed into the fluidized bed reactor 40 via conduit 31, whereby optionally conduit 3 is foreseen for admixing material branched-off from conduit 2 such that the mixed streams are fed into the fluidized bed reactor 40 via conduit 41. Additionally, it is also possible to add further material, like zinc concentrate, in said conduit 41 or a separate feeding device of fluidized bed reactor 40.

Fluidizing gas, often air, streams from below via conduit 42 into fluidized bed reactor 40 to form a fluidizing bed. From this bed, a stream of solid particles are withdrawn via conduit 43 while the fluidizing gas takes at least parts of the particle from the bed and leaves the fluidized bed reactor 40 via conduit 44.

The gas-solid-stream from conduit 44 is passed into a heat exchanger, often called waste-heat boiler, wherein also parts of the solids are removed via conduit 52. The cooled gas stream is than passed into at least one cyclone 60 via conduit 51. Therein, the remaining solids are mostly separated from the gas stream are withdrawn via conduits 62, 73. The gas stream is passed via conduit 61 into electrostatic precipitator 70 to remove remaining particles via conduit 72, which can be admixed to the stream in conduit 73. Any admixing of streams in conduits 41, 43, 52, 62 and 72 possible in any combination. Moreover, removed particles from any of the gas-solid-separation devices can be recycled back into the fluidized bed reactor 40.

Solid particles directly being removed from the fluidized bed via conduit 43 are passing a heat exchanger 80, wherein optionally also particles withdrawn in heat exchanger 50 can be inserted via conduit 52. This solid stream is withdrawn via conduit 81. Conduits 81 and 73 can be combined for transporting the solid streams to a storage or an acid leaching.

### Example

The current invention using a granulation reduces the dust and the associated disadvantages significantly as it can be seen from the data presented in table 2:

TABLE 2
Comparison between a process with and without granulation

| | | Reaction | Reaction | Dust | Dust |
|---|---|---|---|---|---|
| Test ID | Feed | Discharge | Discharge | Entrainment | Entrainment |
| 1 | 155 | 44.6 kg | 39.1 wt.-% | 69.4 kg | 60.9 wt.-% |
| 2 | 149 | 91.8 kg | 73 wt.-% | 33.9 kg | 27 wt.-% |

Test 1 shows the dust entrainment in a fluidized bed roasting without granulation while test 2 uses a feed with the same composition and nearly the same mass flow. The results clearly show that the dust entrainment is reduced for more than 50%.

### LIST OF REFERENCES

1 apparatus for generating zinc oxide residues
2 conduit
3 bypass conduit
10 blending supply
11, 12 conduit
20 granulation device
21, 22 conduit
30 bin
31 conduit
40 fluidized bed reactor
41-44 conduit
50 heat exchanger
51,52 conduit
60 cyclone
61,62 conduit
70 electrostatic precipitator
71-73 conduit
80 heat exchanger
81 conduit

1.-17. (canceled)

18. A process for recycling zinc oxide residues, wherein the zinc oxide residues are granulated to particles with a size of d₈₀ between 0.3 and 5 mm and wherein these particles are fed into a roaster where they are thermally treated at a temperature in the range of 500 and 1.200 C in a fluidized bed to form a calcine, wherein sulfuric acid is admixed to the zinc oxide residues previous and/or during granulating and the granulating is done batch-wise while the roasting is a continuous process, wherein the zinc oxide residues are dusts coming from an electric arc furnace and/or from a Waelz process and/or that the zinc oxide residues are coming from melting and casting of zinc and/or zinc oxide and be crushed to a particle size below d₈₀ 100 μm before being granulated.

19. The process according to claim 18, wherein the zinc oxide residues are granulated to particles with a size of d₈₀ between 0.5 and 2 mm and/or these particles are thermally treated at a temperature in the range of 800 to 1.100 C.

20. The process according to claim 18, wherein the zinc oxide residues are coming from melting and casting of zinc and/or zinc oxide and be crushed to a particle size below d₈₀ 75 μm.

21. The process according to claim 18, wherein the zinc oxide residues are zinc dust with a zinc content of 40 to 80 wt.-%, preferably 60 to 70 wt.-% or the zinc oxides residues are drosses or sludge material with a zinc content between 80 and 99 wt-% or the zinc oxide residues are a mixture of zinc dust and drosses or sludge.

22. The process according to claim 18, wherein the zinc oxide residues contain halogens, carbonates, sulfides and/or sulfates and/or that the zinc oxide residues contain lead.

23. The process according to claim 22, wherein the zinc oxide residues further at least one element from a list comprising cadmium copper, arsenic, silver, PGMs, Pb and silica.

24. The process according to claim 18, wherein zinc concentrate, zinc dust, zinc oxide, sulfur containing residues dust from an electrostatic precipitator and/or dust from cyclone is admixed to the zinc oxide residues previous and/or during and/or after granulating.

25. The process according to claim 18, wherein water is admixed to the zinc oxide residues previous and/or during granulating.

26. The process according to claim 25, wherein sulfuric acid come from a zinc treatment step downward in the process, particularly from an electrowinning or a wet gas cleaning.

27. The process according to claim 25, wherein sulfuric acid come from a zinc treatment step downward in the process from an electrowinning.

28. The process according to claim 26, wherein sulfur content of the particles resulting from the granulating is between 0 and 35 wt-%.

29. A plant for recycling zinc oxide residues, featuring at least one granulator, wherein the zinc oxide residues are granulated to particles with a size of d₈₀ between 0.3 and 5 mm and a roaster, being designed as a fluidized bed reactor, wherein the particles are thermally treated at a temperature in the range of 500 and 1.200 C in a fluidized bed to form a calcine, and means for admixing sulfuric acid to the zinc oxide residues previous and/or during granulating and at least one bin for particles from the granulator are foreseen for a continuous feed into the fluidized bed reactor from a batch-wise operated granulator, wherein at least one apparatus as source for the zinc oxide residues which is an electric arc furnace, a Waelz kiln and/or an apparatus designed to melt and cast zinc and/or zinc oxide.

30. The plant according to claim 29, wherein a high intensive mixer is foreseen as a blending supply upwards of the granulator to admix water, sulfuric acid, zinc containing material and/or sulfur containing material.
